(19) United States
(12) Patent Application Publication
(10) Pub. No.: US 2013/0125070 A1
(43) Pub. Date: May 16, 2013

(54) OPC Checking and Classification

(71) Applicants: Guoqiang BAI, Beijing (CN); Jinguang Li, Beijing (CN); Zijan Yuan, Beijing (CN); Peiyan Liang, Beijing (CN)

(72) Inventors: Guoqiang BAI, Beijing (CN); Jinguang Li, Beijing (CN); Zijan Yuan, Beijing (CN); Peiyan Liang, Beijing (CN)

(21) Appl. No.: 13/297,016

(22) Filed: Nov. 15, 2011

(51) Int. Cl. G06F 17/50

(52) U.S. Cl. 716/52

(57) ABSTRACT

A technique for selecting a subset of determined defects in a mask pattern is described. In this technique, defects in the mask pattern may be determined based on differences between a pattern produced at an image plane in a photolithographic process, when the mask pattern, illuminated by an associated source pattern, is at an object plane in the photolithographic process, and a target pattern that excludes the defects. These defects may be classified by associating them with types of geometric features in the target pattern and/or the mask pattern. Moreover, the subset may be selected by filtering the defects associated with the types of geometric features. For example, the subset may defects corresponding to the differences that exceed filtering values that are associated with the types of geometric features.

### BACKGROUND

1. Field

The present invention relates to systems and techniques for verifying mask patterns.

2. Related Art

Lithography processing represents an essential technology for manufacturing Integrated Circuits and Micro-Electro-Mechanical Systems (MEMS) and Nano-Electro-Mechanical Systems (NEMS). Lithographic techniques are used to define: patterns, geometries, features, shapes, etc. onto an integrated-circuit die, semiconductor wafer, or chips. These patterns are typically defined by: a set of contours, lines, boundaries, edges, curves, etc., which generally surround, enclose, and/or define the boundary of the various regions which constitute the patterns.

One existing lithographic technique is photolithography, in which images defined by photo-masks are printed onto an integrated-circuit die or one or more semiconductor wafers. Unfortunately, it is increasingly difficult to design and manufacture photo-masks.

In particular, demand for increased density of features on the integrated-circuit die and the one or more semiconductor wafers has resulted in the design of circuits with decreasing minimum dimensions. These trends have significantly increased the complexity of the computations necessary to determine the mask patterns (to which the photo-masks correspond), with a commensurate impact on computation time, processing requirements, and expense.

Furthermore, due to the wave nature of light, as dimensions approach sizes comparable to the wavelength of the light used in the photolithography processes, the resulting wafer patterns deviate from the corresponding photo-mask patterns and are accompanied by unwanted distortions and artifacts. Existing techniques (such as Optical Proximity Correction or OPC, and Resolution Enhancement Technologies or RET) are used to pre-distort the mask patterns to improve resolution and/or a process window (e.g., a range of process conditions that result in acceptable yield) in a photolithography process. While these techniques may ensure that the wafer pattern is printed more accurately, determining the pre-distorted mask patterns is increasingly difficult, thereby exacerbating the computational complexity and the associated problems.

Additionally, it is also increasingly difficult to verify that the resulting mask patterns meet predefined design criteria. In particular, as the minimum dimensions of features in the mask patterns are reduced and the complexity of the mask patterns is increased, differences or defects can occur between the wafer patterns produced using the mask pattern and desired target patterns. While some of these defects are more important than others, it is increasingly difficult to assess the relative importance of the defects.

Hence, what is needed is a method and an apparatus that facilitates verification of mask patterns without the above-described problems.

### SUMMARY

The present disclosure relates to a computer system to select a subset of determined defects in a mask pattern. During operation, the computer system receives a mask pattern for use in a photolithographic process. Then, the computer system calculates a pattern produced at an image plane in the photolithographic process when the mask pattern, illuminated by an associated source pattern, is at an object plane in the photolithographic process. Moreover, the computer system determines the defects in the mask pattern based on differences between the calculated pattern and a target pattern that excludes the defects. Next, the computer system classifies the defects by associating the defects with types of geometric features in the target pattern and/or the mask pattern. Furthermore, the computer system filters the defects associated with the types of geometric features to select a subset of the defects, where the subset includes defects corresponding to the differences that exceed filtering values that are associated with the types of geometric features.

Note that the types of geometric features may include topological markers. For example, the types of geometric features may include: an inner corner, an outer corner, a corner, a line end, a space, a jog, and/or a straight edge.

In some embodiments, the computer system provides a list of the subset of defects and the associated classifications. In response to providing the list, the computer system may receive a revised value of at least one of the filtering values from a user of the computer system.

Additionally, after filtering the defects, the computer system may determine an acceptance condition of the mask pattern. For example, the acceptance condition may include a pass or a fail condition. Moreover, determining the acceptance condition may involve accessing predetermined acceptable ranges of the differences, which are stored in a computer-readable memory.

The calculated pattern may include an aerial image. Alternatively or additionally, the calculated pattern may include a simulated wafer pattern based on a model of a photoresist used in the photolithographic process.

In some embodiments, instead of calculating the pattern produced at the image plane in the photolithographic process, the computer system may use an image of a wafer pattern produced in the photolithographic process when determining the differences and, thus, the defects.

Another embodiment provides a method including at least some of the above-described operations performed by the computer system.

Another embodiment provides a computer-program product for use in conjunction with the computer system.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a flow chart illustrating a process for selecting a subset of determined defects in a mask pattern in accordance with an embodiment of the present disclosure.

FIG. 2 is a block diagram illustrating geometric features in a pattern, such as a mask pattern or a target pattern, in accordance with an embodiment of the present disclosure.

FIG. 3A is a drawing illustrating the display of a numerical value of a contact-hole misplacement error for one of the contact-hole features in a mask pattern in accordance with an embodiment of the present disclosure.

FIG. 3B is a drawing illustrating a spatial map of defects associated with a mask pattern in accordance with an embodiment of the present disclosure.

FIG. 4 is a block diagram illustrating a forward optical calculation in accordance with an embodiment of the present disclosure.

FIG. 5 is a block diagram illustrating a mask pattern and corresponding level-set functions in accordance with an embodiment of the present disclosure.

FIG. 6 is a block diagram illustrating a computer system in accordance with an embodiment of the present disclosure.

FIG. 7 is a block diagram illustrating a data structure for use in the computer system of FIG. 6 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of a computer system, a method, and a computer-program product (i.e., software) for use with the computer system are described. These devices and processes may be used to select a subset of determined defects in a mask pattern so that the mask pattern can be improved during the mask-pattern design process and/or an acceptance condition of the mask pattern can be determined. In particular, defects in the mask pattern may be determined based on differences between a pattern produced at an image plane in the photolithographic process, when the mask pattern, illuminated by an associated source pattern, is at an object plane in the photolithographic process, and a target pattern that excludes the defects. These defects may be classified by associating them with types of geometric features in the target pattern and/or the mask pattern. Moreover, the subset may be selected by filtering the defects associated with the types of geometric features. For example, the subset may include defects corresponding to the differences that exceed filtering values that are associated with the types of geometric features.

By classifying and filtering the defects, this verification technique may allow the defects that have the largest negative impact in the photolithographic process to be identified. These defects in the subset may be: corrected in the mask-pattern design process, repaired in a manufactured photo-mask (which corresponds to the mask pattern) and/or excluded (i.e., if the photo-mask includes one of these defects, it may not be used in the photolithographic process). Thus, the verification technique may increase manufacturing yield with a commensurate impact on the cost of wafer produced in the photolithographic process.

In the discussion that follows, a photo-mask should be understood to include: a chromium-on-glass photo-mask, an alternating phase-shifting photo-mask, an attenuating phase-shifting photo-mask, and/or multiple-exposure photo-masks (e.g., where patterns printed on a wafer or semiconductor die using two or more photo-masks are combined to produce a desired or target pattern, such as a portion of an integrated circuit). Furthermore, a mask pattern should be understood to include the pattern of spatially varying transmittance magnitude and/or transmittance phase in a given photo-mask. Note that, typically, the manufactured or fabricated mask pattern in a given photo-mask deviates from an ideal target mask pattern, for example, because of defects that can occur during the photo-mask fabrication process.

In addition, in the discussion that follows note that an image and/or a pattern may include a bitmap or grayscale file that includes a set of values corresponding to pixels in the image and/or the pattern. Furthermore, the quantization (i.e., the number of bits) in these files may be varied, as needed, during the measurements and calculations that are described. Alternative formats having the same or similar information content, including a vector-based format such as a Graphic Design System II (GDSII) and/or an OASIS format, may be used in some embodiments of the images and/or patterns. And in some embodiments, the images and/or patterns include real and imaginary components (or equivalently, magnitude and phase information).

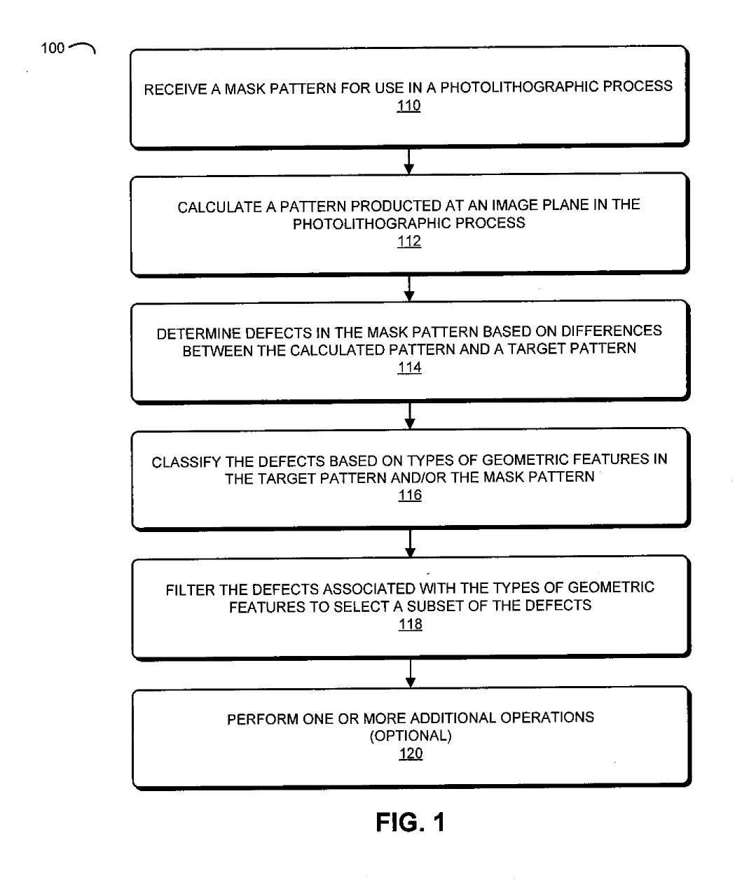

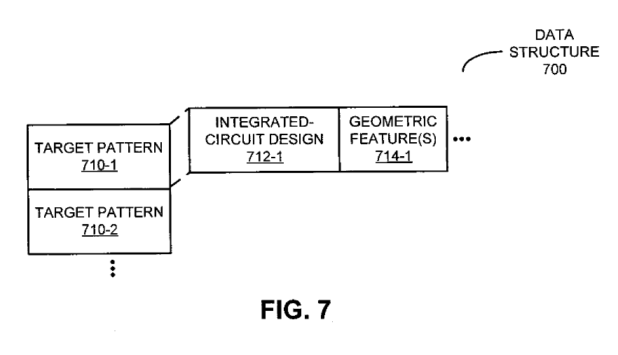

We now describe embodiments of the verification technique. FIG. 1 presents a flow chart illustrating a method 100 for selecting a subset of determined defects in a mask pattern, which is performed by a computer system (such as computer system 700 in FIG. 7). During operation, the computer system may receive a mask pattern for use in a photolithographic process (operation 110). For example, the mask pattern may have been determined using a design tool. Then, the computer system may calculate a pattern produced at an image plane in the photolithographic process (operation 112) when the mask pattern, illuminated by an associated source pattern, is at an object plane in the photolithographic process. For example, the calculated pattern may include an aerial image. Alternatively or additionally, the calculated pattern may include a simulated wafer pattern based on a model of a photoresist used in the photolithographic process. Note that the calculated pattern may be determined using a forward optical calculation with the illuminated mask pattern at an object plane of an optical path associated with the photolithographic process (such as the optical path of an exposure tool) and with the calculated pattern at an image plane of the optical path.

Moreover, the computer system may determine the defects in the mask pattern based on differences between the calculated pattern and a target pattern (operation 114) that excludes the defects.

Next, the computer system may classify the defects by associating the defects with types of geometric features in the target pattern and/or the mask pattern (operation 116). Note that the types of geometric features may include topological markers. For example, the types of geometric features may include: an inner corner, an outer corner, a corner, a line end, a space, a jog, and/or a straight edge.

Furthermore, the computer system may filter the defects associated with the types of geometric features to select a subset of the defects (operation 118), where the subset includes defects corresponding to the differences that exceed filtering values that are associated with the types of geometric features.

In some embodiments, the computer system optionally performs one or more additional operations (operation 120). For example, the computer system may optionally provide a list of the subset of defects and the associated classifications. In response to providing the list, the computer system may optionally receive a revised value of at least one of the filtering values from a user of the computer system.

Alternatively or additionally, after filtering the defects (operation 118), the computer system may optionally determine an acceptance condition of the mask pattern. For example, the acceptance condition may include a pass or a fail condition. Moreover, determining the acceptance condition may involve accessing predetermined acceptable ranges of the differences, which are stored in a computer-readable memory.

In some embodiments of method 100 there may be additional or fewer operations. Moreover, the order of the operations may be changed, and/or two or more operations may be combined into a single operation.

Note that, in some embodiments, instead of calculating the pattern produced at the image plane in the photolithographic process, the computer system may use an image of a wafer pattern produced in the photolithographic process when determining the differences and, thus, the defects.

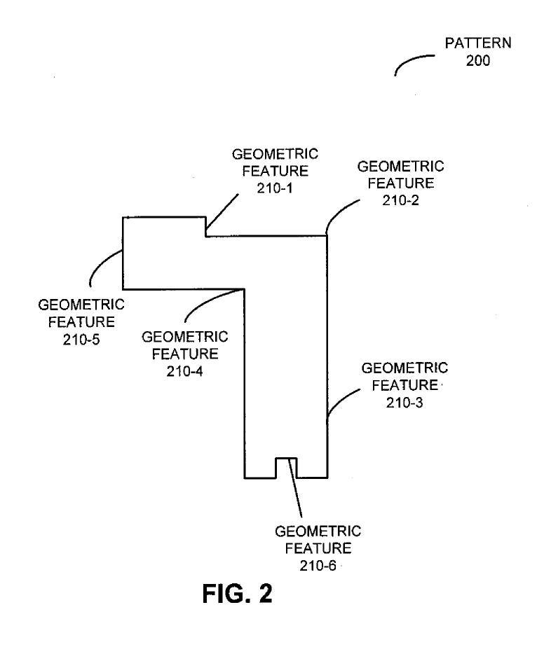

FIG. 2 presents a block diagram illustrating geometric features 210 in a pattern 200, such as a mask pattern or a target pattern. For example, geometric features 210 may include topological markers that are identified in a polygon representation of pattern 200, such as corners (such as inner or concave corners, or outer or convex corners), jogs, straight regions (such as smooth lines or smooth edges), line ends, t-shaped intersections, space ends (such as geometric feature 210-6), holes (such as hole edges, hole jogs, hole inner corners or hole outer corners), etc.

In an exemplary embodiment, a jog (such as geometric feature 210-1) may be less than 5 nm and the associated filtering of defects may occur within ±10 nm of a given jog. Similarly, at line ends, a defect may be associated with actual line width less than a minimum value (such as 60 or 150 nm) and/or a difference in the line-end position more than a minimum value (such as 75 or 100 nm). The line-end filtering of defects may occur within ±4 nm of a given line end. In general, defects may include: an extra feature, a missing feature, a pinched feature, a bridge between features, a feature less than a minimum area, hole shrinkage, hole expansion, hole misplacement, line-end shortening, line-end push out, space-end shortening, space-end push out, a critical-dimension variation, critical-dimension uniformity, edge placement error, a hole-overlap check, a hole-distance check, and/or a double-patterning check. One or more of these defects may change as a function of the light-intensity or dose.

By classifying defects in a mask pattern by associating the defects with geometric features 210, the verification technique may be used to filter the defects and, thus, to select the subset of defects. For example, there may be a large number of small defects associated with line ends. If the classification information is presented to a user of the computer system (such as a mask designer) along with the associated defects, the user may adjust a filtering value associated with this type of geometric defect. Using this filtering value, defects corresponding to differences less than the filtering value may be excluded. For example, differences less than 5% of a critical dimension in pattern 200 that are associated with line ends may be excluded. This filtering process can be repeated for different types of geometric defects, which may allow the user to specify geometric-defect-specific filtering values. In this way, the user can focus on the more important (in this case, the larger) differences by selecting the subset of the defects. In addition, by facilitating geometric-defect-specific filter, this verification technique may assist the user in identifying geometric-defect-related trends in the defects, which may facilitate corrective action when designing the mask pattern.

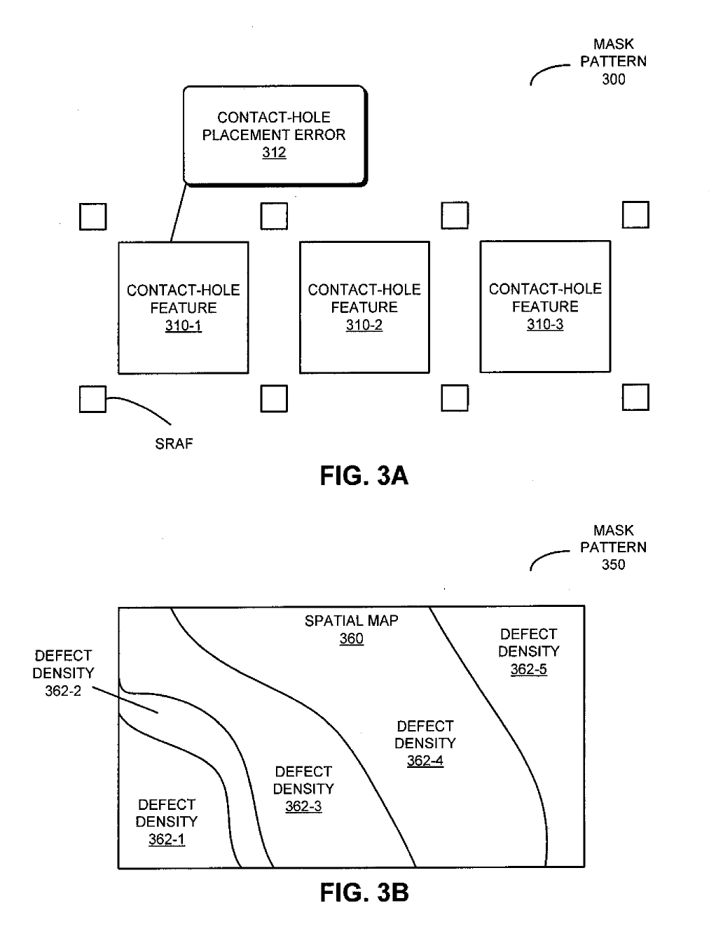

As shown in FIG. 3A, which presents a drawing illustrating display of a numerical value of a contact-hole misplacement error for one of contact-hole features 310 in a mask pattern 300, in another embodiment the computer system may present the contact-hole misplacement error 312 (which is the difference between the actual centroid location of a contact hole produced by one of contact-hole features 310 in mask pattern and a desired centroid location in a target pattern) instead of providing edge-placement errors to the user. This may assist the user when designing the mask pattern because the user will not have to infer contact-hole misplacement error 312 from the edge-placement errors.

As shown in FIG. 3B, which presents a drawing illustrating a spatial map 360 of defects associated with a mask pattern 350, in some embodiments the computer system may present a global spatial map of defects to the user during design of a mask pattern. Note that spatial map 360 may include the distribution of optical-proximity corrections associated with a portion of the mask pattern or over the entire wafer produced using the mask pattern. This spatial map may include colored markers and legends, such as contour lines reflecting defect densities 362, to assist the user in identifying spatial trends in the optical-proximity corrections.

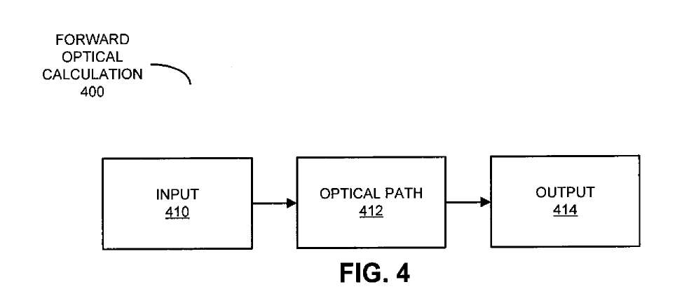

We now describe optical calculations that may be used when verifying a mask pattern. FIG. 4 presents a block diagram illustrating a forward optical calculation 400. In this calculation, a suitable illuminated input 410 (such as a pattern or an image) at an object plane of optical path 412 is used to determine a predicted output 414 (such as a pattern or an image) at an image plane of optical path 412. For example, using the determined mask pattern, a source pattern, and information about the optical path associated with the photolithographic process, the resulting wafer pattern can be determined. (As noted previously, the difference(s) between the wafer pattern, i.e., the estimated or calculated pattern, and the target pattern can be used to determine the cost function.) In general, information about optical path 412 may include some or all of the aspects of the photolithographic process, such as illumination settings, the electromagnetics of the photo-mask, the exposure-tool optics, etc. In addition, in some embodiments forward optical calculation 400 models the effect of a photoresist, including flare and/or etch effects.

Note that calculations corresponding to one or more optical paths in forward optical calculation 400 may be implemented using Fourier-optical techniques. Furthermore, the optical path in forward optical calculation 400 may include multiple models of optical paths (such as when there are different exposure tools used in multi-exposure photolithography). Also note that while optical path 412 has been traversed in particular directions, this optical path may be traversed in either direction.

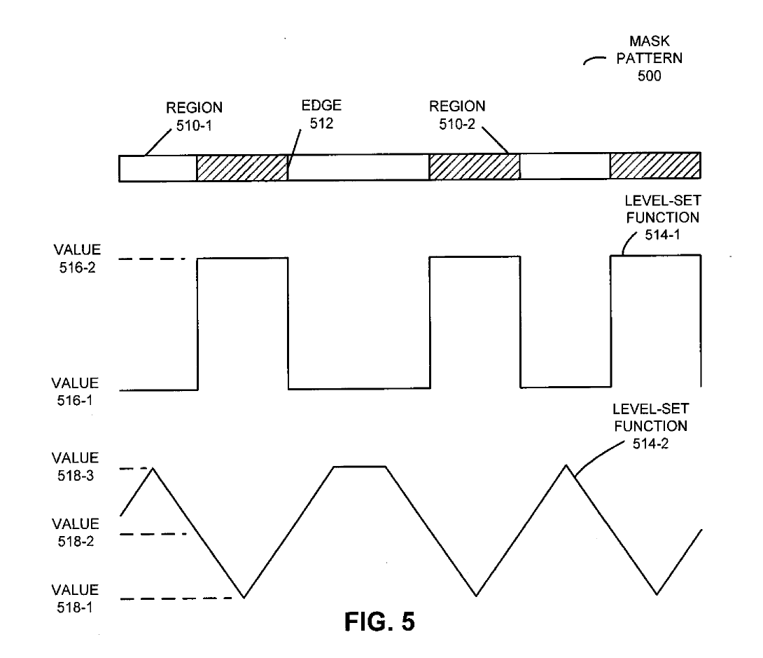

We now describe an exemplary embodiment of the forward optical calculation or forward projection operation used to calculate the estimated pattern (i.e., the calculated pattern) at the image plane in the photolithographic process. For simplicity, coherent illumination of the photo-mask (which corresponds to the mask pattern) is utilized. Furthermore, the electric field falling upon the photo-mask is approximately constant. Thus, the clear regions of the photo-mask pass the light, while the opaque regions block the light. It follows that a scalar electric field E, just behind the photo-mask, may be expressed as

$$E ( \vec{r} ) = \{ \begin{matrix}0 & chrome \\ 1 & glass\end{matrix} \} ,$$

where \vec{r}=(x, y) is a point on the (x,y) plane. As discussed below with reference to FIG. 5, this representation of the photo-mask may be re-expressed using a function φ (referred to as a level-set function) having positive regions that indicate glass and negative regions that indicate chrome. Furthermore, the level-set function may equal zero at the boundaries or contours of the photo-mask. Therefore, the electric field E associated with the photo-mask may be re-expressed as a function of this level-set function, i.e.,

E(\vec{r})=ĥ(φ(x,y)),

where ĥ is the Heaviside function

$${\hat{h}}^{ } ( x ) = \{ \begin{matrix}1 & x \geq 0 \\ 0 & x < 0\end{matrix} \} .$$

Since an ideal diffraction limited lens acts as a low-pass filter, this may be used as an approximation to the actual (almost but not quite perfect) lens in the optical path in the photolithographic process (in this example). Mathematically, the action of the lens may be expressed as

A(\vec{r})=f⁻¹(Ĉ(f(E(\vec{r}))))

where A(\vec{r}) indicates the electric field distribution on the wafer, f indicates the Fourier transform, f⁻¹ indicates the inverse Fourier transform, and Ĉ indicates the pupil cutoff function, which is zero for frequencies larger than a threshold determined by the numerical aperture of the lens, and one otherwise. Thus, the pupil function is

$$\hat{C} ( {k}_{x} , {k}_{y } ) = \hat{h} ( {k}_{max}^{2} - [ {k}_{x}^{2} + {k}_{y}^{2} ] ) = \{ \begin{matrix}0 & {k}_{x}^{2} + {k}_{y}^{2} \geq {k}_{max}^{2} \\ 1 & {k}_{x}^{2} + {k}_{y}^{2} < {k}_{max}^{2}\end{matrix} \} ,$$

wherein kₓ, k_{y} and kₘₐₓ represent frequency coordinates in Fourier space. Therefore, the estimated pattern at the image plane in the photolithographic process is simply the square of the electric field

I(\vec{r})=|A(\vec{r})|²

Combining these two equations, we find

F(φ(x,y))=(|f⁻¹(Ĉ(f(ĥ(φ(x,y))))|²)

This is a self-contained formula for the estimated pattern determined by when designing the mask pattern.

Note that this is just one embodiment of the forward projector that can be used within the scope of this disclosure, chosen by way of example due to its relative simplicity. More sophisticated forward models also fall within the scope of the present disclosure. Such models may take into account, by way of example but not limitation, various illumination conditions (e.g., off-axis, incoherent), the actual electromagnetics of the light field interacting with the photo-mask, various types of photo-masks other than chrome on glass (e.g., attenuated phase shifting, strong phase shifting, other materials, etc.), the polarization of the light field, the actual properties of the lens (such as aberrations), and/or the vector nature of the electromagnetic field as it propagates through the optical path.

We now describe the level-set functions in more detail. As noted previously, the mask pattern may be represented as a function having a set of values that is larger than those in the actual photo-mask. In some embodiments, the function is a level-set function. This is illustrated in FIG. 5, which provides a mask pattern 500 and corresponding level-set functions 514. This mask pattern includes alternating regions with glass (510-1) and chromium (510-2). Transitions from one region to another are characterized by a contour or an edge, such as edge 512. When viewed from a direction perpendicular to a plane of the photo-mask, edge 512 defines mask pattern 500.

Level-set function 514-1 has two values 516. Furthermore, edge 512 may correspond to a mid-point between these two values 516. In contrast, level-set function 514-2 has three values 518, and edge 512 may correspond to value 518-2. While not illustrated in FIG. 5, level-set functions 514 extend into the plane of FIG. 5 (e.g., they may be 3-dimension functions). As is known to one of skill in the art, there are many alternate level-set functions and/or configurations that may be used. For example, in some embodiments one or more separate level-set functions and/or separate patterns or images may be used for the features or defects.

As illustrated by level-set function 514-2, in some embodiments the level-set function may be expressed as a signed distance function relative to the contour or edge 512 (e.g., the value of the level-set function in at least a region is a function of the distance from the edge 512). This formulation may allow effects that occur nearer to the edge 512 to be highlighted. However, because features in photo-masks may occur at random locations (including those far removed from edge 512), level-set function 514-1 may be useful in that it provides an equal weighting with respect to edge 512.

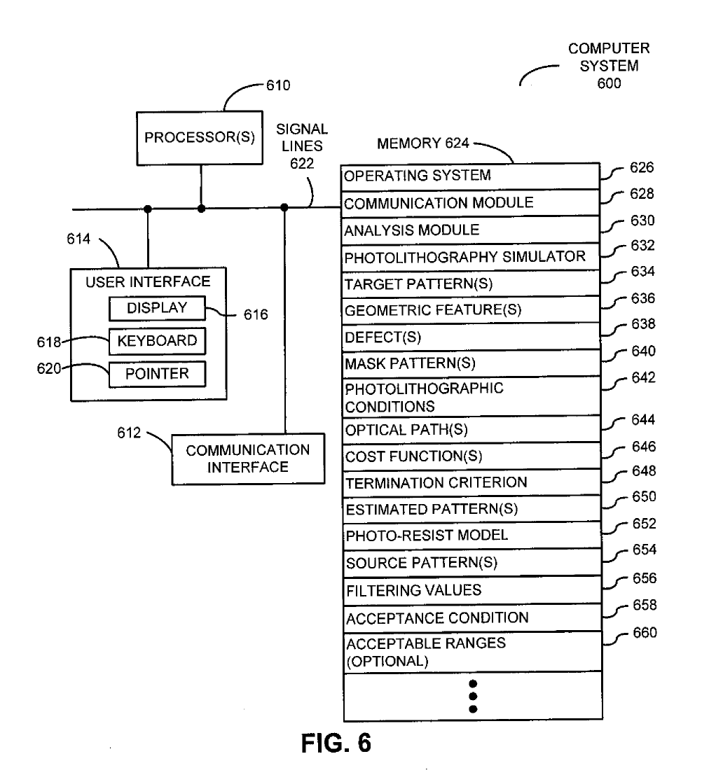

We now discuss computer systems for implementing the verification technique. FIG. 6 presents a block diagram illustrating a computer system 600. Computer system 600 includes one or more processors 610, a communication interface 612, a user interface 614, and one or more signal lines 622 coupling these components together. Note that the one or more processing units 610 may support parallel processing and/or multi-threaded operation, the communication interface 612 may have a persistent communication connection, and the one or more signal lines 622 may constitute a communication bus. Moreover, the user interface 614 may include a display 616, a keyboard 618, and/or a pointer 620, such as a mouse.

Memory 624 in the computer system 600 may include volatile memory and/or non-volatile memory. More specifically, memory 624 may include ROM, RAM, EPROM, EEPROM, flash, one or more smart cards, one or more magnetic disc storage devices, and/or one or more optical storage devices. Memory 624 may store an operating system 626 that includes procedures (or a set of instructions) for handling various basic system services for performing hardware dependent tasks. The memory 624 may also store procedures (or a set of instructions) in a communication module 628. The communication procedures may be used for communicating with one or more computers and/or servers, including computers and/or servers that are remotely located with respect to the computer system 600.

Memory 624 may also include multiple program modules (or a set of instructions), including: analysis module 630 (or a set of instructions), and/or photolithography simulator 632 (or a set of instructions). Note that one or more of these program modules (or sets of instructions) may constitute a computer-program mechanism. Furthermore, note that one or more of these program modules (or sets of instructions) may be implemented as a stand-alone software application, or as a program module or subroutine in another application.

During operation, computer system 600 may receive one or more target patterns 634 (which include polygons) associated with an integrated-circuit design. Then, analysis module 630 may determine one or more geometric features 636 in the one or more target patterns 634. FIG. 7 presents a block diagram illustrating a data structure 700. This data structure may include target patterns 710 for different integrated-circuit designs. For example, for a given target pattern, such as target pattern 710-1, data structure 700 may include: integrated-circuit design 712-1 and/or geometric features 714-1.

Referring back to FIG. 6, photolithography simulator 632 may subsequently calculate one or more mask patterns 640 that can be used in a photolithographic process (having associated photolithographic conditions 642) to fabricate the one or more target pattern 634 on a semiconductor die, where the one or more mask patterns 640 may be calculated using an inverse optical calculation in which a given one of the one or more target patterns 634 is at an image plane of one of one or more optical paths 644 associated with the photolithographic process and the one or more mask patterns 640 are at an object plane of one of the or more optical paths 644 and are illuminated by one or more source patterns 654 (which may be predefined or which may be calculated by photolithography simulator 632). Next, analysis module 630 may evaluate one or more cost functions 646 to determine if a termination criterion 648 is met, where a given one of the one or more cost functions 646 corresponds to a difference between the one or more target patterns 634 and one or more estimated patterns 650 produced during the photolithographic process at the image plane using the one or more mask patterns 640 at the object plane. If termination criterion 648 is not met, analysis module 630 may modify the one or more mask patterns 640 and repeats the calculation until termination criterion 648 is met.

Note that photolithography simulator 632 may calculate the one or more estimated pattern 650 using the one or more mask patterns 640, at least one of the one or more optical paths 644 and/or a photoresist model 652.

In some embodiments, instead of or after calculating the one or more mask patterns 640, computer system 600 receives (or accesses) the one or more mask patterns 640. Then, photolithography simulator 632 may calculate the one or more estimated patterns 650 at an image plane in the photolithographic process when the one or more mask patterns 640, which are illuminated by the one or more source patterns 654, are at an object plane in the photolithographic process.

Moreover, analysis module 630 may determine or identify defects 638 in the one or more mask patterns 640 based on differences between the one or more estimated patterns 650 and the one or more target patterns 634 that excludes defects 638. Next, analysis module 630 may classify defects 638 by associating defects 638 with types of geometric features 636 in the one or more target patterns 634 and/or the one or more mask patterns 640. Furthermore, analysis module 630 may filter defects 638 associated with geometric features 636 to select a subset of defects 638, where the subset includes defects corresponding to the differences that exceed filtering values 656 that are associated with the types of geometric features 636.

In some embodiments, computer system 600 provides a list of the subset of defects 638 and the associated classifications. In response to providing the list, computer system 600 may receive a revised value of at least one of filtering values 656 from a user of computer system 600.

Additionally, after filtering the defects, analysis module 630 may determine an acceptance condition 658 of at least one of the one or more mask patterns 640. For example, acceptance condition 658 may include a pass or a fail condition. Moreover, determining acceptance condition 658 may involve accessing optional predetermined acceptable ranges 660 of the differences.

Instructions in the various modules in memory 624 may be implemented in a high-level procedural language, an object-oriented programming language, and/or in an assembly or machine language. The programming language may be compiled or interpreted, i.e., configurable or configured to be executed, by the one or more processing units 610.

In some embodiments, at least some of the information in memory 624 is encrypted. For example, the photolithographic simulator 632 and/or its output files may be encrypted. Moreover, information ‘stored’ in memory 624 in FIG. 6 may be stored locally and/or at remote locations.

Although the computer system 600 is illustrated as having a number of discrete items, FIG. 6 is intended to be a functional description of the various features that may be present in the computer system 600 rather than as a structural schematic of the embodiments described herein. In practice, and as recognized by those of ordinary skill in the art, the functions of the computer system 600 may be distributed over a large number of servers or computers, with various groups of the servers or computers performing particular subsets of the functions. In some embodiments, some or all of the functionality of the computer system 600 may be implemented in one or more ASICs, one or more field programmable gate arrays (FPGAs), and/or one or more digital signal processors (DSPs). In some embodiments the functionality of the computer system 600 may be implemented more in hardware and less in software, or less in hardware and more in software, as is known in the art.

In the preceding discussion, a ‘computer system’ may include a variety of devices, such as: a personal computer, a laptop computer, a mainframe computer, a portable electronic device, a server and/or a client computer (in a client-server architecture), and/or other device capable of manipulating computer-readable data or communicating such data between two or more computing systems over a network (such as the Internet, an Intranet, a LAN, a WAN, a MAN, or combination of networks, or other technology enabling communication between computing systems).

In some embodiments, forward optical calculation 400 (FIG. 4), mask pattern 500 and corresponding level-set functions 514 (FIG. 5), computer system 600, and/or image data structure 700 (FIG. 7) include fewer or additional components. Furthermore, in these embodiments two or more components are combined into a single component and/or a position of one or more components may be changed.

While the preceding discussion used a photolithography as an illustrative example, in other embodiments the calculation technique may be applied to mask-less lithography. In these embodiments, the inverse optical calculation may be used to determine a write pattern instead of a mask pattern.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for selecting a subset of determined defects in a mask pattern, comprising:
receiving a mask pattern for use in a photolithographic process;
using the computer, calculating a pattern produced at an image plane in the photolithographic process when the mask pattern, illuminated by an associated source pattern, is at an object plane in the photolithographic process;
determining the defects in the mask pattern based on differences between the calculated pattern and a target pattern, wherein the target pattern excludes the defects;
classifying the defects by associating the defects with types of geometric features in the target pattern; and
filtering the defects associated with the types of geometric features to select a subset of the defects, wherein the subset includes defects corresponding to the differences that exceed filtering values that are associated with the types of geometric features.

2. The method of claim 1, wherein the types of geometric features include at least one of: an inner corner, an outer corner, a corner, a line end, a space, a jog, and a straight edge.

3. The method of claim 1, wherein the types of geometric features include topological markers.

4. The method of claim 1, wherein the method further comprises providing a list of the subset of defects and the associated classifications.

5. The method of claim 4, wherein, in response to providing the list, the method further comprises receiving a revised value of at least one of the filtering values from a user.

6. The method of claim 1, wherein, after filtering the defects, the method further comprises determining an acceptance condition of the mask pattern.

7. The method of claim 6, wherein the acceptance condition includes a pass or a fail condition.

8. The method of claim 6, wherein determining the acceptance condition involves accessing predetermined acceptable ranges of the differences, which are stored in a computer-readable memory.

9. The method of claim 1, wherein the calculated pattern includes an aerial image.

10. The method of claim 1, wherein the calculated pattern includes a simulated wafer pattern based on a model of a photoresist used in the photolithographic process.

11. A computer-program product for use in conjunction with a computer system, the computer-program product comprising a non-transitory computer-readable storage medium and a computer-program mechanism embedded therein to select a subset of determined defects in a mask pattern, the computer-program mechanism including:
instructions for receiving a mask pattern for use in a photolithographic process;
instructions for calculating a pattern produced at an image plane in the photolithographic process when the mask pattern, illuminated by an associated source pattern, is at an object plane in the photolithographic process;
instructions for determining the defects in the mask pattern based on differences between the calculated pattern and a target pattern, wherein the target pattern excludes the defects;
instructions for classifying the defects by associating the defects with types of geometric features in the target pattern; and
instructions for filtering the defects associated with the types of geometric features to select a subset of the defects, wherein the subset includes defects corresponding to the differences that exceed filtering values that are associated with the types of geometric features.

12. The computer-program product of claim 11, wherein the types of geometric features include at least one of: an inner corner, an outer corner, a corner, a line end, a space, a jog, and a straight edge.

13. The computer-program product of claim 11, wherein the types of geometric features include topological markers.

14. The computer-program product of claim 11, wherein the computer-program mechanism further includes instructions for providing a list of the subset of defects and the associated classifications.

15. The computer-program product of claim 14, wherein, in response to providing the list, the computer-program mechanism further includes instructions for receiving a revised value of at least one of the filtering values from a user.

16. The computer-program product of claim 11, wherein, after filtering the defects, the computer-program mechanism further includes instructions for determining an acceptance condition of the mask pattern.

17. The computer-program product of claim 16, wherein determining the acceptance condition involves accessing predetermined acceptable ranges of the differences, which are stored in a computer-readable memory.

18. The computer-program product of claim 11, wherein the calculated pattern includes an aerial image.

19. The computer-program product of claim 11, wherein the calculated pattern includes a simulated wafer pattern based on a model of a photoresist used in the photolithographic process.

20. A computer system, comprising:
at least one processor;
at least one memory; and
at least one program module, the program module stored in the memory and configured to be executed by the processor to select a subset of determined defects in a mask pattern, the program module including:
instructions for receiving a mask pattern for use in a photolithographic process;
instructions for calculating a pattern produced at an image plane in the photolithographic process when the mask pattern, illuminated by an associated source pattern, is at an object plane in the photolithographic process;
instructions for determining the defects in the mask pattern based on differences between the calculated pattern and a target pattern, wherein the target pattern excludes the defects;
instructions for classifying the defects by associating the defects with types of geometric features in the target pattern; and
instructions for filtering the defects associated with the types of geometric features to select a subset of the defects, wherein the subset includes defects corresponding to the differences that exceed filtering values that are associated with the types of geometric features.
